(19) United States
(12) Patent Application Publication
(10) Pub. No.: US 2006/0216603 A1
(43) Pub. Date: Sep. 28, 2006

(54) Lithium-ion rechargeable battery based on nanostructures

(75) Inventor: Sung H. Choi, Canyon Country, CA (US)

Correspondence Address: LAW OFFICES OF GARY SCHNITTGRUND, 28001 Smyth Drive, Suite 105, Valencia, CA, 91355-4030, US

(73) Assignee: Enable IPC

(21) Appl. No.: 11/089,781

(22) Filed: Mar. 26, 2005

(51) Int. Cl. H01M 4/48; H01M 4/52; B05D 5/12

(52) U.S. Cl. 429/231.95; 429/231.3; 429/223; 427/126.3; 427/126.6

(57) ABSTRACT

A nanowire-based Li-ion rechargeable battery having superior performance with little capacity fade for use in applications including consumer electronics and medical devices is made by incorporating nanowire construction of the cathode. The nanowire-based battery system includes a nanostructured high surface area cathode structure fabricated by electrodeposition using alumina nanopore templates.

### BACKGROUND OF THE INVENTION

1. Field of the Invention

This invention relates to novel, nanowire-based lithium-ion rechargeable batteries with little capacity fade for use in consumer electronics and medical devices.

2. Description of Related Art including information disclosed under 37 CFR 1.97 and 1.98

The lithium-ion (Li-ion) battery has been the leading energy storage material since the mid-1990s. The Li-ion battery has competition from rechargeable batteries based on lead-acid, reusable alkaline, nickel cadmium (NiCd), nickel metal hydride (NiMH) and sodium-sulfur or Li-sulfur systems. Today, there are four commonly used rechargeable batteries:

Nickel metal hydride (NiMH) batteries, first developed in the 1970s, are used primarily for portable communication equipment, audio and video equipment, premium electronic devices and other products;

NiCd (nickel cadmium) batteries are used primarily for emergency lighting, communication equipment and backup devices;

Li-ion batteries, introduced in 1991 (with Li-ion polymer batteries introduced in 1999), are used primarily for portable communication equipment (e.g., cell phones, PDAs), notebook computers, and other portable electronic devices; and

Sealed Lead Acid (SLA) batteries, introduced in the late 1960s and early 1970s, are used primarily for emergency lighting, backup devices and some laptop computers.

The basic components of each system are very similar—each consists of a positive electrode (cathode), negative electrode (anode), separator and electrolyte. But, the chemistry of each battery is different, depending on its technology, and each offers different performance characteristics.

Li-ion batteries have many advantages over competing technologies, including the following.

Low maintenance. Li-ion is a low maintenance battery, an advantage that most other chemistries cannot claim.

No memory effect. There is no memory and no scheduled use/charge cycling required to prolong the battery's life.

Higher capacity. Li-ion batteries can deliver 40% more capacity than nickel cadmium (NiCd) batteries and are one of the lightest rechargeable batteries available today, having about half the weight of Ni—Cd batteries and being about 30-50% smaller in volume. They are the batteries of choice in notebook computers, wireless telephones and many digital camera and camcorder models.

Low self-discharge. Li-ion batteries also have a lower self-discharge rate than other types of rechargeable batteries. This means that once they are charged they will retain their charge for a longer time than other battery chemistries. NiMH and NiCd batteries can lose up to about 5% of their charge per day, (depending on the storage temperature) even if they are not installed in a device. Li-ion batteries, on the other hand, will lose only about 0.16% per month of their charge per month in storage.

Fast recharge. Li-ion batteries also recharge quickly, with an 80% percent charge in one hour and a full charge within 2.5 hours.

The concerns of Li-ion batteries include:

Capacity Retention with Aging. Many manufacturers do not address the aging issue, but a few claim up to 500 recharge cycles before any substantial loss of capacity starts to occur. After 1,000 recharge cycles the capacity of Li-ion cell drops to about 50% of its original rating. In some cases, capacity deterioration is noticeable after one year, whether the battery is in use or not. The battery frequently fails after two or three years. It should be noted that nickel-based batteries (especially NiMH) also have age-related degenerative effects, notably when they are exposed to higher temperatures;

Expense. Li-ion batteries are one of the most expensive rechargeable technologies, primarily because they are more complex to manufacture. Li-ion batteries include special circuitry to protect the battery from damage due to overcharging or undercharging; and

Manufacturability. In addition, they are manufactured in much smaller numbers than NiMH or NiCd batteries.

Li-ion batteries are market forerunners due to their compact size, high energy density and power source stability to above a few hundred cycles. It's easy to measure the performance of rechargeable batteries by their energy density and their life expectancy. The following points summarize the reason why Li-ion batteries are the market leader, compared with other battery chemistries:

conventional nickel batteries have a lower discharge voltage than Li-ion batteries and also experience a detrimental memory effect;

NiCd batteries are toxic;

nickel metal hydrides have a reduced cycle life;

rechargeable alkaline batteries have a very short life of about 50% capacity after 50 cycles;

the sulfur systems have a very high capacity at high temperatures, which can't be easily utilized; and

lead-acid batteries are durable and inexpensive, but they are toxic and have a low energy density.

Li-ion rechargeable battery is known as a “rocking chair” battery due to the two-way motion of the Li ions. The Li ions are transported between the anode and the cathode through the electrolytes. During charging the Li ions undergo deintercalation from the cathode into the electrolyte, at the same time Li ions intercalate from the electrolyte into the anode. Intercalation is the process of inserting Li ions into the structure of the electrodes. During discharging, the intercalation and deintercalation reverse. The shift in charge, due to Li ion movement during charging and discharging is compensated by electron flow through the external circuit.

Research has been carried out on three major components (cathode, anode, and electrolyte) of the Li-ion battery. The desired characteristics of cathode materials include a high discharge voltage, a high energy capacity, a long cycle life, and a high power density. In addition, materials must be easy to handle, stable chemically, non-toxic, and low cost for high throughput. In the early 1990s, research focused on lithium-iron-phosphate systems as cathode materials. The lithium cobaltate (LiCoO₂) cathode has a layered structure. This layered structure has good conductivity of lithium ions and electrons. The lithium ions can intercalate or deintercalate between the layers. Lithium cobaltate batteries have an energy density of 140 Wh/kg and a life expectancy of 300 cycles, with 50% capacity after 500 cycles. The voltage and capacity gradually decrease with the number of charging cycles. However, this process gives the battery a finite life. Alternative cathode material systems include LiNiO₂, a solid solution of LiCoO₂, and LiNiO₂, LiMn₂O₄, LiMyMn_{2-y}O₄ (M is a metal atom) and other oxides as well as olivine-structured compounds such as LiFePO₄.

Thin-film based Li-ion batteries have been demonstrated as a means of fabricating batteries. The thin film components of the Li-ion batteries (such as current collector, cathode, electrolyte, anode, and a protective coating) are deposited by conventional sputtering or evaporation and subsequent microfabrication techniques. These types of batteries are reported to be fabricated on various substrates, such as silicon, alumina, and plastics, and there is no limit on the area dimensions. However, the processes used to produce thin-film batteries, such as high-vacuum sputtering, are expensive. In addition, Parylene, a material typically used in this process as a protective coating, is reported to have gas permeability that leads to degradation of battery performance.

The power density of a Li-ion battery is dictated, at the fundamental level, by the electrochemical kinetics of charge transfer at the electrode/electrolyte interface and the kinetics of solid-state diffusion of lithium ions in and out of the host electrodes. Thus, the rate capability of battery electrodes is highly dependent on the grain size, texture, surface area, and morphology of the electrode materials. The ability to engineer an ordered, large surface area structure of electrochemically active materials on the nanoscale can yield enhanced charge/discharge characteristics. It is known that high surface area nanowire electrodes of SnO₂ and V₂O₅ significantly improve the rate capability compared with thin films of the same materials. Nanostructured electrodes of V₂O₅ deliver four times the capacity of V₂O₅ thin film electrode at a fixed discharge rate at 500° C. The synthesis of nanowire electrode arrays results in electrodes without binders or conductive additives, other than the thin film substrate support, which is typically no more than 200 nm of vacuum deposited metal. This electrode design results in improvements in electrode energy density compared with conventional Li-ion cathodes.

Although technology of fabricating nanowire cathodes deposited on a free-standing nanopore template by electrodeposition can provide a possibility of fabricating high-surface area cathodes leading to high performance (high power, high charge-rate) Li-ion rechargeable battery, it has serious limitations when it comes to enabling the development of the next generation of high-performance Li-ion rechargeable battery applications. Specifically, it is very difficult to integrate all components such as Li-ion rechargeable battery, sensors, and electrical devices on a single chip by utilizing conventional non-silicon technologies. Since a completed system powered by the Li-ion rechargeable battery typically consists of many discrete electrical components that need to be assembled to connect to each other, a completed system cannot be manufactured at a low cost, even at high production level. More importantly, a conventional process of fabricating nanowire cathode battery based on a free-standing template are not compatible with silicon planar technology, which, if used, cannot lower manufacturing costs.

A conventional method of fabricating nanowire cathode Li-ion rechargeable battery on an integrated circuit 17 is to deposit nanowire as cathodes in the pores of a free-standing nanopore template by electrodeposition followed by wafer bonding on a silicon substrate having a CMOS circuit or other electronic devices. FIG. 1 illustrates a process of depositing nanowires, such as for a Li-ion rechargeable battery cathode, prepared by electrodeposition using a free-standing nanopore template on a silicon CMOS circuit substrate.

The fabrication of nanowire on a silicon CMOS circuit substrate is described. First, a seed layer 1 (usually gold) is deposited on aluminum foil 2 which is anodized to form nanopores 15 on a sheet 3. The resulting free-standing sheet 3 is used as a template for growing a vertical array of nanowires 15, which may serve as the Li-ion battery cathode. The nanowires 4 are deposited in the nanopores 15 and are preferably comprised of LiCoO₂ or LiCO₂NiO₂. A subsequent chemical etch with NaOH for 30 minutes results in exposed nanowires 4 on the seed layer 1. CMOS circuit device 6 and other devices 7, such as sensors, powered by a nanowire battery are predeposited on a silicon substrate 8 prior to the deposition of nanowires 4 for the Li-ion rechargeable battery device. The components, such as nanowire battery, CMOS circuit devices 6, and other devices 7 powered by nanowire battery, are connected by electrically conductive lines 9. Once the nanowires 4 are deposited on the freestanding template sheet 3, the sheet 3 is bonded to the CMOS circuit silicon substrate 8.

Since it is difficult to fabricate a completed battery device with a freestanding sheet 3 having nanowires 4 as a cathode, for example, the process for fabricating a battery device with template sheet 3 is done on a bonded silicon CMOS circuit substrate 8. Prior to bonding, a gold layer 10 is deposited on the substrate 8 where the freestanding template sheet 3 contains nanowires 4. The gold layer 10 on the substrate 8 is used to bond the freestanding template sheet 3 onto the substrate 8. However, because there is typically a large mismatch between the template sheet 3 materials and the silicon substrate 8, bonding usually results in a large number of manufacturing defects, resulting is low production yield. In addition, since a freestanding template sheet 3 cannot be perfectly flat, it is difficult to achieve a smooth process for the remainder of the wafer bonding process. Further, bonding also requires sophisticated and costly procedures to carry out.

A need exists for a Li-ion battery with little capacity fade.

### BRIEF SUMMARY OF THE INVENTION

The present invention is directed to nanowire-based Li-ion rechargeable batteries that have very little capacity fade. A battery cathode made of nanowires of an electrodeposited lithium oxide; and where the cathode has 10¹⁰ to 10¹² nanowires per square centimeter. The nanowires have a diameter of about 10 to 200 nanometers and the lithium oxide is LiCoO₂ or LiCoNiO₂. The cathode has a surface area of less than about 1000 times the corresponding surface area resulting from the basic geometric shape.

A method of making a nanowire structure by selecting a cathode material suitable for forming a lithium ion battery, depositing an aluminum layer on a silicon substrate, anodizing the aluminum layer to alumina forming a nanopore template of a plurality of nanopores, widening the nanopores by chemical etching, and growing nanowires inside the nanopores.

The novel features of the invention are set forth with particularity in the appended claims. The invention will be best understood from the following description when read in conjunction with the accompanying drawings.

### OBJECTS OF THE INVENTION

It is an object of the invention to form nanowires on a lithium-ion battery cathode.

It is an object of the invention to provide a high surface area cathode for a lithium-ion battery.

It is an object of the invention to form nanowires by electrodeposition.

Other objects, advantages and novel features of the present invention will become apparent from the following detailed description of the invention when considered in conjunction with the accompanying drawing.

### BRIEF DESCRIPTION OF THE SEVERAL VIEWS OF THE DRAWINGS

The present invention may be best understood by referring to the following detailed description of the preferred embodiments and the accompanying drawings, wherein like numerals denote like elements and in which:

FIG. 1 illustrates the conventional process steps for fabricating a Li-ion rechargeable battery cathode with nanowire deposited by electrodeposition.

FIGS. 2A, 2B, and 2C present the process steps for fabrication of nanowires for a lithium ion battery by the new process.

FIG. 3 presents a process schematic for patterning alumina nanopore templates.

FIG. 4 illustrates scanning electron photomicrographs of a nanopore template.

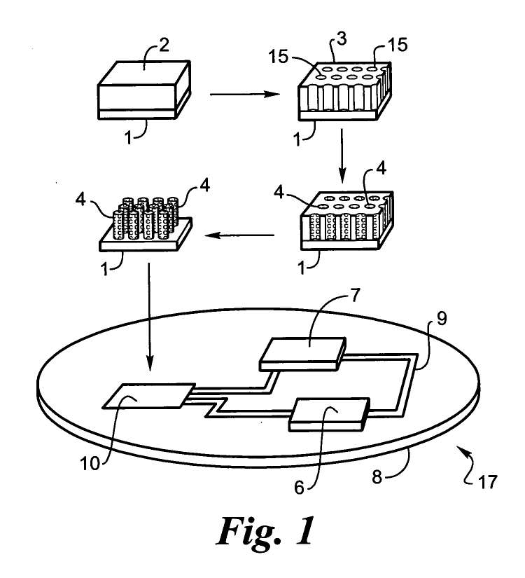

### DETAILED DESCRIPTION OF THE INVENTION

The inventor's nanowire-based Li-ion rechargeable batteries have superior electrical performance with little capacity fade and are applicable for use in many applications, including consumer electronics and medical devices. Nanowires are defined as a wire having a diameter of less than one micron. Electrodeposition fabrication of nanowires using anodized aluminum nanopore membranes as template materials is cost effective and manufacturable. The diameter and length of nanowires can be precisely controlled and the structure of nanowires can be optimized to increase the battery capacity while increasing the charge/discharge rates more than 100 times greater than that of known electrodes.

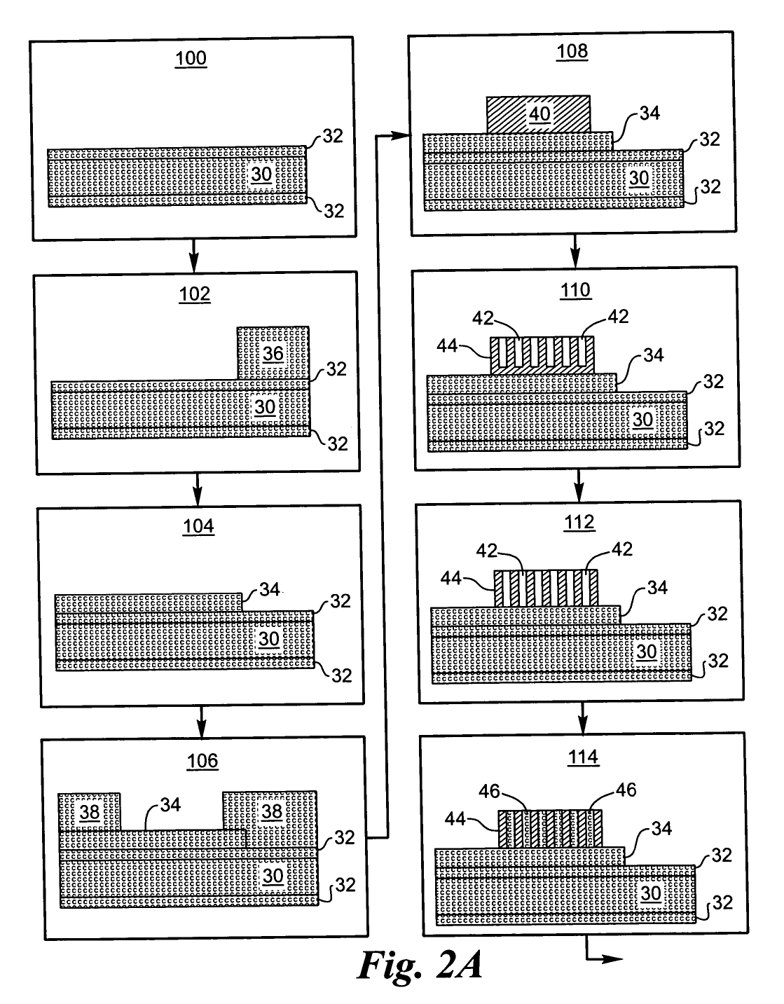

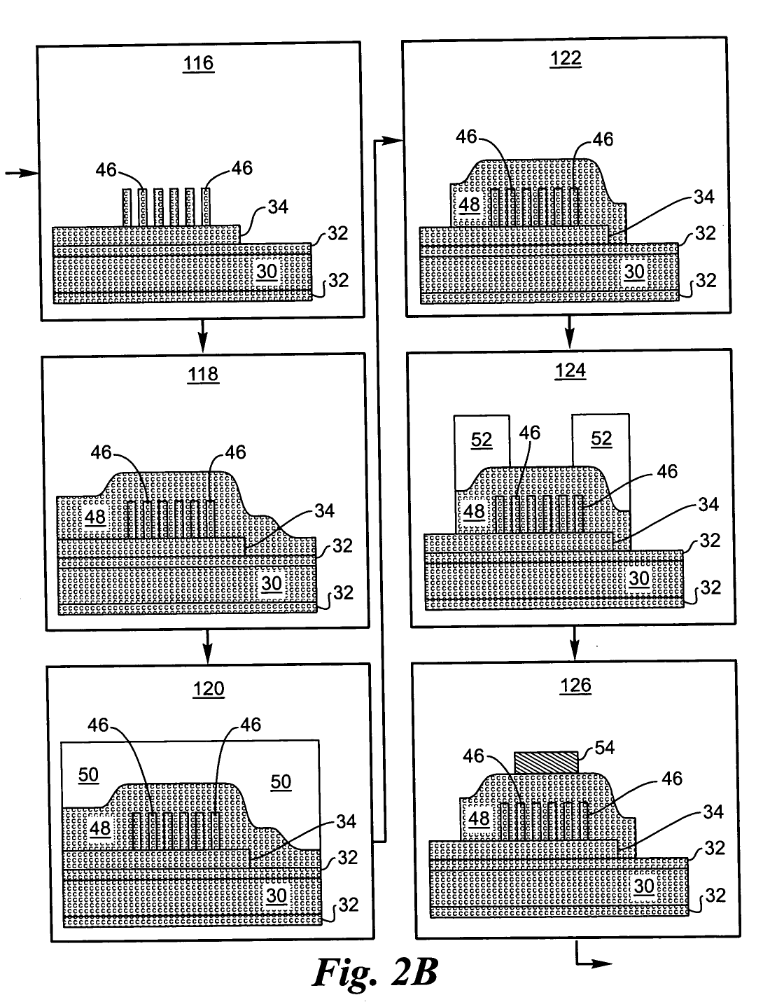

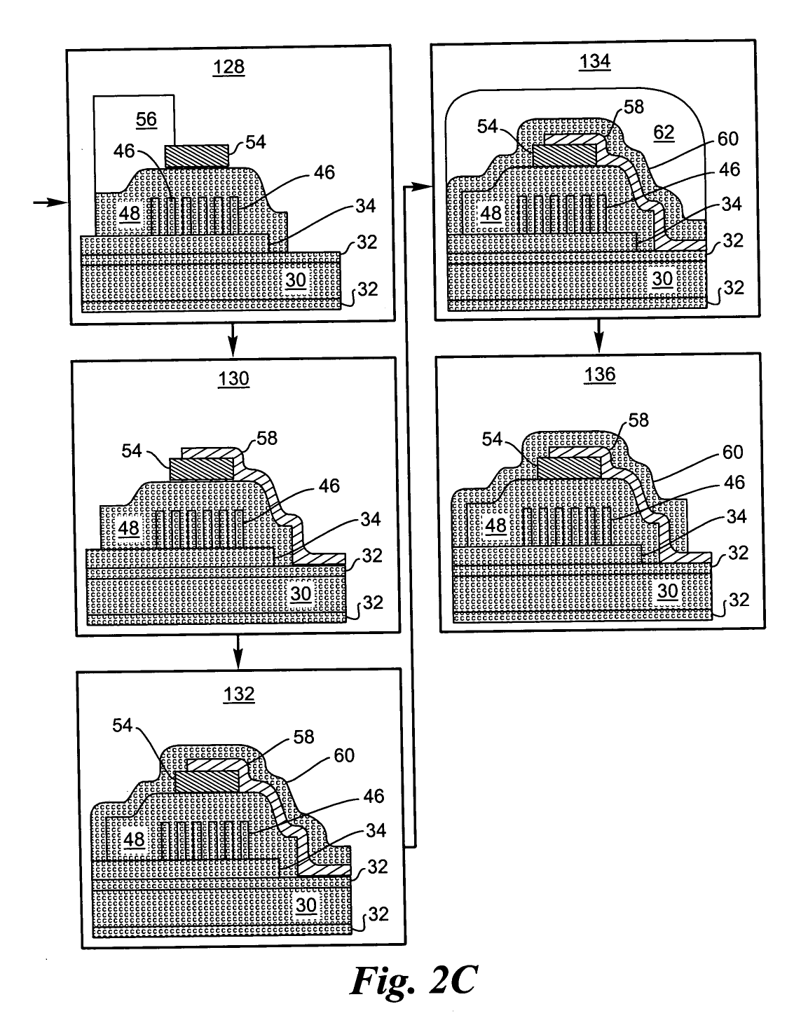

The present invention applies nanotechnology to fabricate nanowire-based Li-ion rechargeable battery cathodes that can be integrated with electronic devices, such as CMOS circuitry or other electrical/optical devices, which in turn can be powered by a Li-ion rechargeable battery that may be integral with the integrated circuit. The invention enables growth of a nanopore template on a substrate, preferably silicon, before nanowire deposition on a template. Fabrication is CMOS compatible. FIGS. 2A, 2B, and 2C present the procedure for fabrication of a high surface area nanowire Li-ion rechargeable battery cathode.

In a preferred embodiment, nanowire-based cathodes include a novel nanostructured high-surface-area electrode structure fabricated by electrodeposition along with alumina nanopore templates. A nanopore is defined as a pore having a diameter of less than one micron. The nanostructured high-surface-area electrodes are formed on silicon dioxide/silicon or sapphire substrates or polymer substrates (polyimide, liquid crystal polymer) to form the cathode. The nanowire-based cathodes are fabricated using a conventional template process in which the pores of an anodized alumina template are filled with cathode materials by electrodeposition. The alumina nanopore template is formed by sputtering or evaporating a thin seed layer of gold followed by a layer of aluminum on silicon dioxide/silicon or alumina substrates or polymer substrates (polyimide, liquid crystal polymer). The aluminum is then electro-polished, to remove surface defects, and anodized to generate the pores and convert the aluminum to alumina. Electro-polishing is a kind of a surface etching process caused by an applied electrical potential. The size of the pores in the alumina nanopore template is controlled by adjusting the anodizing parameters, including solution composition, operating temperature, and applied voltage.

After the pores have been formed and widened by the anodizing process, cathode nanowires are formed in each of the pores by electrodeposition. As mentioned above, the number and size of the pores (and therefore the precise number of nanowires) are managed by control of the anodizing parameters, as discussed above. Once the pores have been filled with cathode materials via the electrodeposition process, the anodized alumina template is chemically dissolved, leaving an array of nanowire-based cathode electrodes formed on the silicon dioxide/silicon or sapphire substrates or polymer substrates (polyimide, liquid crystal polymer).

The fabrication sequence to generate a nanowire-based Li-ion rechargeable battery consists of the following steps.

200 nm thick silicon dioxide 32 is grown by thermal oxidation on the substrate surface 30 at 900 C for about 30 minutes at 760 torr in an atmosphere of oxygen, step 100.

Step 102, optical lithography is used to pattern for a cathode ion collector 34 on substrate 30. Photoresist 36 is coated on the substrate 30 in a 1 um thick layer by conventional spin coating techniques. Spin coating is done at a spin speed of 4000 revolutions per minute for 30 seconds. Photoresist AZ 5214 is preferred.

Step 104, cathode ion collector 34 is deposited by metal patterns of 10 nm titanium covered by 150 nm platinum by electron beam evaporation and a subsequent lift-off process.

Step 106, optical lithography is used to deposit 10 um thick photoresist layer 38 as a pattern for an aluminum layer.

Step 108, a 1.5 μm thick aluminum layer 40 is deposited by e-beam evaporation at 9 kV and is patterned by a lift-off process.

Step 110, 1.5 μm thick aluminum layer 40 is anodized to alumina to fabricate nanopore template 44 containing a plurality of nanopores 42, which are used for growing high-surface-area nanowire cathodes for Li-ion battery. Anodized alumina templates have high pore densities (e.g. 10² to 10³ pores per μm²) with straight pore holes. The pore size can be controlled by adjusting anodizing conditions including solution compositions (sulfuric, oxalic, phosphoric, chromic or their mixtures), operating temperature and applied voltage (current). Use of anodized alumina templates is a cost effective method of fabricating nanowires.

The estimated active reacting surface of each electrode is approximately 680 cm² for a nanowire having a diameter of 50 nm compared to a flat surface area of 0.78 cm².

In a preferred embodiment, nanowire-based cathodes for Li-ion rechargeable batteries are created by using alumina nanopore templates and electrodeposition. Anodized aluminum is the key material for fabrication of nanostructured devices in a template. Straight, ordered pores measuring 10 to 200 nm in diameter are made with ultra high-density pore structures (10¹⁰ to 10¹² cm⁻²). Anodized alumina is electrically insulating, having a resistivity of 10¹⁸ ohm-cm, and is optically transparent over a wide energy band range, chemically stable, and is compatible with CMOS processes. Anodization of aluminum in oxalic or sulfuric acid results in highly ordered honeycomb structures. Pore dimensions of 10 nm to 200 nm can be controlled by adjusting the anodizing solution composition and the applied current density. Pore dimensions and the distance between pores (density) in alumina templates are controlled by selecting the anodizing solution, potential and current density, temperature and agitation. Pores having dimensions of 10 nm to 200 nm in diameter with porosity on the order of 30-40% can be made for applications to nanowire-based cathodes. Ordering of nanopores in alumina templates is promoted by using a two-step anodization instead of a one-step anodization.

The first anodized layer is removed, and acts as the nucleation site for second anodization to promote higher ordering of nanopores. Pre-texturing the aluminum surface with molding processes, ion beam, and/or holographic patterning will be considered to enhance ordering in alumina templates.

Step 112, the nanopores 42 are widened to an average approximate diameter of 50 nm using 0.2 M of mixed H₂SO₄/H₃PO₄, which completes the anodizing process. The etchant is at room temperature and etches for 30 minutes.

Step 114, nanowires 46 are grown inside nanopores 42. The nanowires 46 are fabricated of LiCoO₂ and LiCoNiO₂. Pure Co nanowires are formed from cobalt sulfate bath containing 0.2 M CoSO₄+0.7 M Na₂SO_{4+0.4} M H₃BO₃+0.0075 M Saccharin, (pH=3) at 10 mAcm². Concentrated NaOH is used to remove the anodized alumina nanotemplate 44, although KOH or may also be employed, leaving exposed Co nanowires 46, step 116. The conversion of Co and Co—Ni to LiCoO₂ and LiCoNiO₂ is accomplished by hydrothermal treatment of an aqueous LiOH solution, although anodic oxidation may also be employed.

Step 118, a 2 μm thick LiPO₄ electrolyte layer 48 is deposited by sputtering.

Step 120, optical lithography is used to pattern the LiPO₄ electrolyte layer 48 by depositing photoresist layer 50. Photoresist 50 is coated on the substrate 30 in a 1 μm thick layer by conventional spin coating techniques. Spin coating is done at a spin speed of 4000 rpm for 30 seconds. Photoresist AZ 5214 is preferred.

Step 122, a reactive ion etching process with a mixture of CF₄ and Ar₂ in a mixing ratio of 4:1 is used to define patterns in LiPO₄ electrolyte layer 48. Etching is done at 200 W for 30 minutes. Subsequently the photoresist layer 50 is stripped with acetone.

Step 124, optical lithography is used to deposit photoresist 52 for the anode patterns. Photoresist 52 is coated on the substrate 30 in a 1 μm thick layer by conventional spin coating techniques. Spin coating is done at a spin speed of 4000 rpm for 30 seconds. Photoresist AZ 5214 is preferred.

Step 126, a 1 μm thick anode layer 54, comprised of either SnO₂—SiO₂ alloy or Sn, is laid down by sputtering deposition at 10 kV or e-beam evaporation at 9 kV and a subsequent lift-off process.

Step 128, optical lithography is used to deposit photoresist 56 to pattern anode current collector 58. Photoresist 56 is coated on the substrate 30 in a 1 μm thick layer by conventional spin coating techniques. Spin coating is done at a spin speed of 4000 rpm for 30 seconds. Photoresist AZ 5214 is preferred.

Step 130, a layer of 500 nm thick titanium is deposited by sputtering to form anode current collector 58. Subsequently, patterns of anode current collector 58 are defined by a lift-off process.

Step 132, a 1.5 μm thick film of liquid crystal polymer (LCP) film 60 as a protective layer is deposited by Chemical Vapor Deposition (CVD) process.

Step 134, optical lithography is used to deposit photoresist layer 62 to pattern a LCP layer 60. Photoresist 62 is coated on the substrate 30 in a 1 μm thick layer by conventional spin coating techniques. Spin coating is done at a spin speed of 4000 rpm for 30 seconds. Photoresist AZ 5214 is preferred.

Step 136, the LCP film 60 is patterned by ion-milling using argon or oxygen plasma using oxygen at 200 W. Subsequently, photoresist 62 is stripped by acetone.

The above template process results in electrodes having typical dimensions of 4 μm², with an array of approximately 1600 nanowires (the exact number determined by the parameters of the anodizing process). The active reacting surface of each electrode is approximately 680 cm² compared to a flat surface area of 0.78 cm².

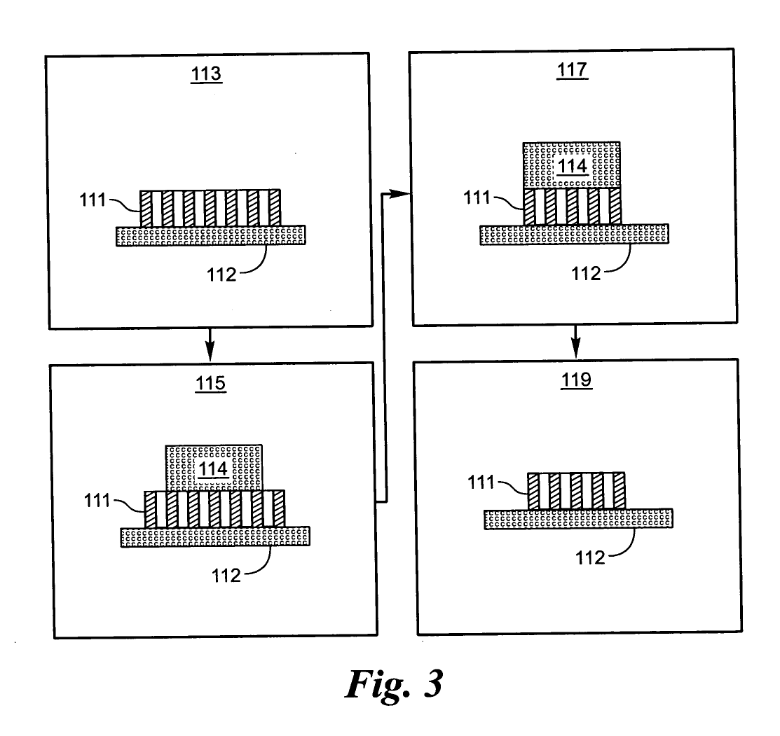

Positioning nanowires on a substrate is a key technology for fabricating nanowire-based devices. In a Li-ion rechargeable battery, an alumina nanopore template is patterned by ion milling after it is grown on the substrate. Electrodeposition is utilized to grow nanowire cathodes in the registered area. An alternative embodiment to producing nanowire patterns by a process of patterning a nanopore template, pre-grown on a substrate, is presented in FIG. 3.

In FIG. 3, step 113, an alumina nanopore template 111 is grown on the substrate 112 by anodization; in step 115 optical lithography defines a photoresist layer 114 on a nanopore template; in step 117 a photoresist layer 114 is transferred onto a nanopore template 111 by ion-milling for 20 minutes, leaving a pattern of the nanopore template 111. Step 119, removing a layer of photoresist 114 leads to patterned nanopore template 111 on the substrate 112.

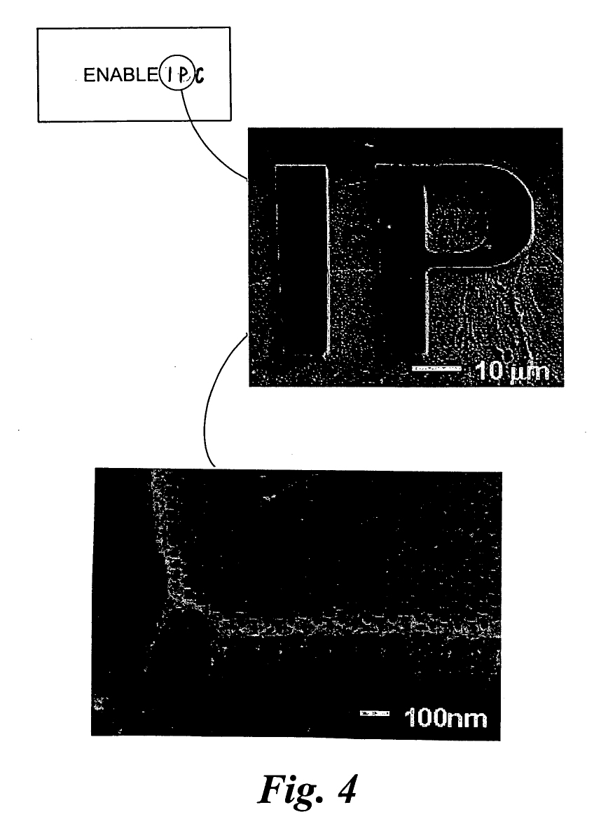

FIG. 4 represents scanning electron photomicrographs of a nanopore pattern as a result of patterning an alumina nanopore template. The nanopore pattern of the letters “IP” is 10 μm wide and consists of 50 nm diameter pores.

Obviously, many modifications and variations of the present invention are possible in light of the above teachings. It is therefore to be understood that, within the scope of the appended claims, the invention may be practiced otherwise than as specifically described.

What is claimed is:

1. A structure comprising:
a cathode comprised of nanowires suitable for use in a lithium ion battery;
said nanowires comprised of an electrodeposited lithium oxide; and
said cathode comprised of 10¹⁰ to 10¹² nanowires per square centimeter.

2. The structure according to claim 1, wherein said nanowires have a diameter of about 10 to 200 nanometers.

3. The structure according to claim 1, wherein said lithium oxide is comprised of LiCoO₂ or LiCoNiO₂.

4. The structure according to claim 1, wherein said cathode has a surface area of less than 1000 times the corresponding surface area resulting from the basic geometric shape.

5. A method of making a nanowire structure comprising the steps of:
selecting a cathode material suitable for forming a lithium ion battery;
depositing an aluminum layer on a silicon substrate;
anodizing said aluminum layer to alumina forming a nanopore template comprised of a plurality of nanopores;
widening said nanopores by chemical etching; and
growing nanowires comprised of said cathode material inside said nanopores.

6. The method according to claim 5, wherein said step of selecting a lithium ion battery cathode material is selecting LiCoO₂ or LiCoNiO₂.

7. The method according to claim 5, wherein said step of depositing an aluminum layer is depositing by e-beam evaporation.

8. The method according to claim 5, wherein said step of anodizing an aluminum layer to alumina is forming an alumina layer having a thickness of about 1 to 2 microns.

9. The method according to claim 5, wherein said step of forming a nanopore template comprised of a plurality of nanopores is forming nanopores having a diameter of about 10 to 200 nanometers.

10. The method according to claim 5, wherein said step of widening said nanopores by chemical etching is etching in phosphoric acid.

11. The method according to claim 5, wherein said step of growing nanowires is electrodepositing said cathode material.

12. The method according to claim 5, further comprising the step of chemical vapor depositing a liquid crystal polymer film on said lithium ion battery.

13. The method according to claim 12, further comprising the step of ion milling said film.
